(19) United States
(12) Patent Application Publication
(10) Pub. No.: US 2020/0085039 A1
(43) Pub. Date: Mar. 19, 2020

(54) Seed Adhesive Mixture and Method of Making the Same

(71) Applicants: Brian R. Jaasko, Amity, OR (US); Paul Jaasko, Corvallis, OR (US)

(72) Inventors: Brian R. Jaasko, Amity, OR (US); Paul Jaasko, Corvallis, OR (US)

(21) Appl. No.: 16/130,479

(22) Filed: Sep. 13, 2018

(51) Int. Cl. A01N 25/24

(52) U.S. Cl. CPC A01N 25/24; A01C 1/06

(57) ABSTRACT

Methods and compositions are provided for to creating a beneficial micro-environment to a seed by adhering additives to the seed. Included with the seeds are various accessory structures and compounds which promote the development and survival of the plant and which function to impede the progress of competitors.

### BACKGROUND OF THE INVENTION

This invention relates to a composition for improving germination rates, and, more specifically to a composition for adhering additives to seeds and controlling dust, with application in the fields of forestry, agronomy, and commercial and amateur horticulture.

### FIELD OF THE INVENTION

The conventional techniques of crop and plant delivery in agriculture include placing seed directly in the ground either by hand or machine planting. Either of these techniques may be incorporated in a broadcast or precision sowing method. Such seed is commonly planted untreated or sometimes treated to a brief dip in a fungicide or covered with a layer of dry diatomaceous earth (or other appropriate material) with or without dried preparations of microorganisms. Additionally, seeds may be coated with compounds (such as methyl cellulose or sodium alginate) in which a solvent is required for coating of the seed. Subsequently, the solvent is evaporated or dried off to result in a final coating that is not saturated or complexed ionically. Saturation is a concept incorporated herein which is defined to be where no more solvent or liquid can be absorbed or retained.

As an alternative, such seeds, treated or untreated, are first sown in greenhouse or nursery beds. Plantlets are raised to a particular size before transplanting to the field. Conventional methods of seed planting and transplant production are well known and described in the literature. See, e.g., J. H. Martin and W. H. Leonard, “Principles of Field Crop Production,” (Macmillan Company, N.Y., 1949); J. H. MacGillivray, “Vegetable Production,” (Blakiston Co., N.Y., 1953); and R. L. Carolus, “Possibilities with the Use of Pelleted Seed” (Ohio Veg. and Potato Growers Assoc., Ann. Proc. 34: 56062, 1949).

The conventional technique of delivery of additives that affect plant, insect, fungus, bacteria, animal and other growth is to apply the additive physically separate from the plant seed. Plant nutrients, pesticides, beneficial microorganisms and other biologically active compounds are applied (1) before the time of seed planting by soil incorporation or by placement on top of the soil, (2) to the soil as the seeds are being planted, or (3) after the seeds are planted by soil incorporation, spray application, or other physical means. Conventional methods are well known and described in the literature. See, e.g. J. Janick, R. W. Schery, F. W. Woods, V. W. Ruttan, “Plant Science,” (W. H. Freeman, San Francisco, 1974); and “Western Fertilizer Handbook,” (Institute Printers and Publishers, Danville, Ill., 1975).

A major limitation to these conventional methods is the requirement to plant the seeds and deliver the additives separately, usually by way of separate passes through the field with the tractor. This is costly as well as harmful since it increases the incidence of soil compaction due to the tractor weight.

An additional limitation is that the additive is not precisely applied to the specific points in the field where the additive reacts with the seed or its microenvironment. For beneficial microorganisms, the specific application point is at the seed, where developing roots will interact with the applied microorganisms. The same application point is suggested for herbicides to limit weed competition, nematicides to control root invading nematodes, insecticides to control both root and upper plant-attacking insects, nutrients to nourish the developing plant, as well as other additives to benefit seed establishment and growth. Because additive application by conventional methods is non-precise much of the additive is wasted or non-effective.

A further limitation is that many additives are volatile, flammable, toxic or otherwise environmentally hazardous, and therefore, pose difficulty in handling and application for both the operator and the environment.

A still further limitation is that conventional methods do not provide a system for delivery of a seed that has undergone seed inbibition (priming) but which seed has not then been subsequently dried.

It has been recognized that some of these difficulties may be overcome by incorporating some of the additives, specifically micro-organisms, in a dry covering around the seed. See, e.g., T.V. Suslow and M. N. Schroth (Phytopathology 72: 199, 1982). This technique provides for direct application of microorganisms with the seed. However, the process to coat the seed requires that both the seeds and microorganisms be dried, a process that often results in decreased seed germination rates and death of a majority of the microorganisms.

It has also been recognized that the additives can be applied to the seed in the form of a wet seed coating (water added to facilitate the coating process), which coating is subsequently dried to form a less than saturated seed coating around the seed. See, e.g., Scott (U.S. Pat. No. 2,967,376). However, the process to coat the seeds requires that both the seeds and additives be subsequently dried, a process that damages the seed if priming has occurred.

Another technique which has found some use is fluid drilling. Pre-germinated seeds are delivered, occasionally with microorganisms or other additives, in a thick slurry by means of special implements. See, e.g. Taylor, J. D. and C. L. Dudley, “Rhizobium. Inoculation of Dwarf Beans”, Nat. Veg. Res. Sta. U.K. 28th Ann. Rep. p. 105 (1977); Hardaker, J. M. and R. C. Hardwick, “A Note on Rhizobium Inoculation of Beans”, Expl. Agric. 14:17-21 (1978); Entwistle, A. R. and H. L. Munasinghe, “The Control of White Rot (Sclerotium cepivorum) in Fluid-drilled Salad Onions” J. Hort. Sci. 56:251-54 1981). However, this method does not allow for singulation of seeds in a deliverable, saturated D capsule. Further, this method does not permit precise seed planting. Seed viability is often reduced, and specialized planting equipment is required.

A further technique which has been suggested for delivery of seeds is to mix the seeds in a hydrogel of a high molecular weight hydrophilic polymer. The polymer, preferably containing a basic carboxylic acid salt residue, is cross-linked. The resultant mixture is combined with water to form a non-sticky hydrogel. The hydrogel, combined with seeds, is poured or dribbled along a row of soil to affect seed germination. See, e.g., S. Kitamura, M. Watanabe, M. Nakayama, and S. Ouchii (Japanese Patent 1983 33508, assigned to Sumitomo Chemical Co.). However, this process is similar to fluid drilling and does not allow for seed singulation nor allow for precision seed planting. Furthermore, the hydrogel/seed mixture is not a unitized, easily handled package that can be planted using existing seed handling and planting equipment.

It has been suggested that additives be microencapsulated to provide controlled release of the additives, thereby lengthening the time of activity. See, e.g., T. J. Roseman and S. Z. Mansdorf, “Controlled Release Delivery Systems” (Marcel Dekker, Inc., N.Y., 1983. However, this technique does not provide for precision placement of the additives where they will be most effective.

Thus, an object of this invention is to provide a technique whereby seeds are advantageously combined with additives prior to planting.

Another object of this invention is to control germination and development of the seeds.

Yet another object of the invention is to provide a saturated medium to deliver the seeds together with additives.

A further object of the invention is to reduce the amount of handling and time required for delivery of seeds and additives to field, nursery, or greenhouse.

A still further object of the invention is to provide a delivery method for seeds and additives.

A final object of the invention is to control the release of the seeds and additives.

### BRIEF SUMMARY OF THE PRESENT INVENTION

In accordance with the invention, methods and compositions are provided for delivering seeds and beneficial additives as a unit by encapsulating these components and adhering them directly to a seed. Also included with the seeds are various accessory structures and compounds which promote the development and survival of the plant and which function to impede the progress of competitors.

The accessory structures and compounds normally included with seeds can be substituted or supplemented by various additives including beneficial growth additives or biologically active compounds that will enhance the seed's ability to thrive and compete more successfully for resources. These various additives can be mixed together in a homogeneous aqueous solution and subsequently adhered to the seed. The seed and adhered additives are then dried to remove most of the water.

In accordance with the invention, seeds and additives are combined for delivery by adhering the additives to the seeds in a method which can control dust, aid germination and development of the seeds.

### BRIEF DESCRIPTION OF THE FIGURES

FIG. 1 is a diagram showing the components of a seed adhesive mixture as according to an embodiment of the present invention; and

FIG. 2 shows a method for making a seed adhesive mixture as according to an embodiment of the present invention;

A further understanding of the present invention can be obtained by reference to a preferred embodiment set forth in the accompanying description. Although the illustrated embodiments are merely exemplary of methods for carrying out the present invention, both the organization and method of operation of the invention, in general, together with further objectives and advantages thereof, may be more easily understood by reference to the illustrations and the following description. The figures are not intended to limit the scope of this invention, but merely to clarify and exemplify the invention.

### DETAILED DESCRIPTION OF THE INVENTION

In the following detailed description, reference is made to specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention”, “alternative embodiment(s)”, and “exemplary embodiment(s)” do not require that all embodiments of the method(s) or apparatus include the discussed feature, advantage or mode of operation. The following description of the preferred embodiment is merely exemplary in nature and is in no way intended to limit the invention, its application, or use.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter. Those skilled in the art will appreciate that the conception upon which this disclosure is based may be readily utilized as a basis for the designing of other structures, methods and systems for carrying out the purposes of the present invention. It is important, therefore, that any embodiments of the present invention be regarded as including such equivalent constructions insofar as they do not depart from the spirit and scope of the present invention.

Further, the purpose of the Abstract herein is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application nor is it intended to be limiting as to the scope of the invention in any way.

For purposes of this Description, the term “fluid” shall include any substance that continually deforms or flows under an applied force. Fluids, as described herein, shall include, but not be limited to, liquids, gases, plasmas, or any other substance that cannot resist a shear force applied to it. Some examples of fluids include water, gasoline, oil, acids, hydrogen, diols, oxygen, alcohols or the like.

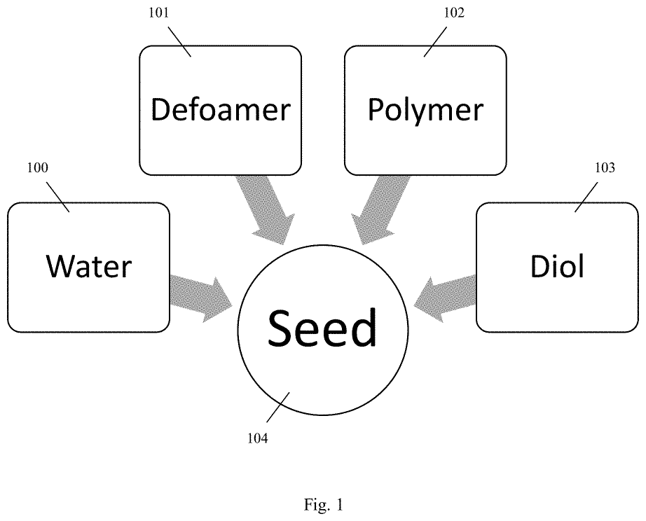

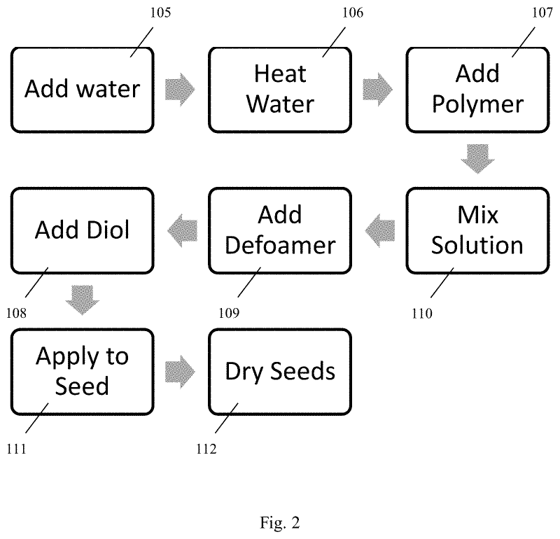

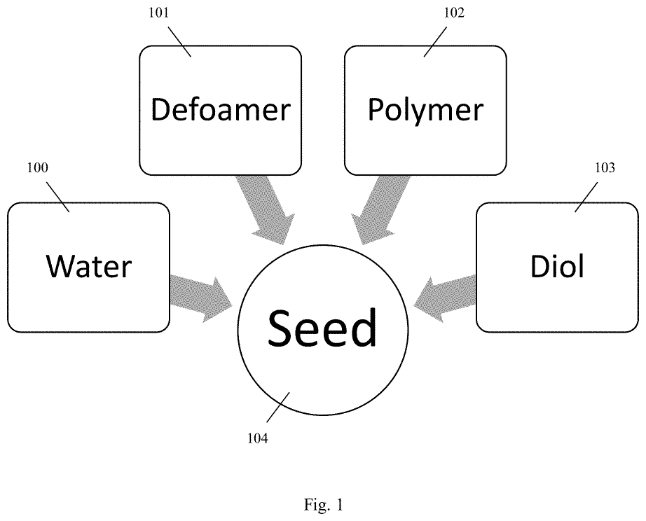

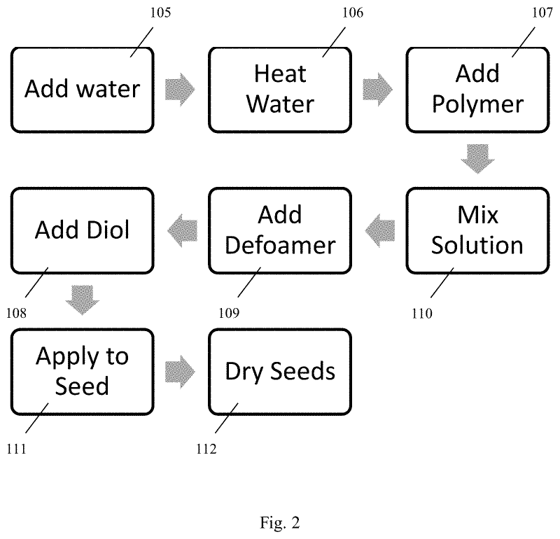

Referring to FIGS. 1-2 that will be discussed together, there is shown a seed adhesive mixture and method for making the same that protects a seed (104) from predation, mechanical injury, aids with dust control, and improves germination. The components comprise water (100), a defoamer (101), a polymer (102), and a diol (103) that are mixed together and added to the seed (104). The mixing is done in a plurality of stages, at varying temperatures, and are performed over specified time intervals.

In an embodiment of the present invention, polyvinyl alcohol is used as the polymer (102). Ethylene glycol is used as the diol (103). In some alternative embodiments of the invention, sugar is used as the polymer (102). These embodiments can be used when an organic seed adhesive mixture is desired. Additionally, even when using polyvinyl alcohol as the polymer (102), sugar can be adhered to the seed to benefit, as an example, legume crops. In other alternative embodiments of the invention, a fungicide can be added to inhibit fungal growth on the seeds. In embodiments using sugar, the sugar can be fibregum bio, a food grade FDA-GRAS (nb 184-1330) that meets all the requirements of the Food Chemical Codex. Fibregum bio can also be labelled as organic acacia gum, a soluble dietary fibre.

In an embodiment of the present invention, an adhesive seed mixture is prepared in an industrial tank mixer. Water (100) is added (105) to the tank and is heated to approximately 180 degrees Fahrenheit (108). Once the water (100) reaches the desired temperature, the polyvinyl alcohol (102) is added (107). Enough polyvinyl alcohol (102) is added (107) so that the mixture is comprised of less than 10% polyvinyl alcohol (102). In an embodiment of the present invention, the mixture comprises approximately 92% water (100) and 8% polyvinyl alcohol (102). In some embodiments of the present invention, sugar can be optionally added to the adhesive seed mixture as a polymer (102) instead of the polyvinyl alcohol, or in addition to the polyvinyl alcohol. In these embodiments, enough sugar is added to comprise approximately 8% of the mixture.

The adhesive seed mixture is mixed for approximately an hour (110). The mixing (110) can be done by a device such as a tank-mounted electric drive mixer. Once the mixing (110) is finished, a defoamer is added (109), defoamer is added (109) so that the mixture contains less than 1% defoamer. In some embodiments, the percentage of the mixture contains approximately 0.0008% defoamer. In some embodiments, the defoamer can be a silicone defoamer

Ethylene glycol (103) is added (108) to the mixture. Enough ethylene glycol (103) is added to comprise approximately 0.5% to 10% of the mixture. In an embodiment of the present invention, 3% of the mixture is comprised of ethylene glycol (103).

After the ethylene glycol (103) is added (108) a mixture is created. The mixture is then applied to the seed (111). Application to the seed (111) can be done by placing the seeds in an industrial mixer and slowly adding the adhesive seed mixture. In an example of the present invention, seeds are added to a rotating drum mixer and the adhesive seed mixture is slowly added by way of a tube that delivers the aqueous adhesive seed mixture solution. Seeds are rotated in the drum, the adhesive seed mixture is poured into the drum, and agitating blades cause the mixture to coat the seeds.

After applying the adhesive seed mixture to the seeds (111), the seeds are then dried (112) to remove a majority of the water from the adhesive mixture. The seeds can pass through one or more dryers that heat the seeds to a temperature sufficient to remove the water, but do not sterilize or cause damage to the seeds. In an embodiment of the present invention, the seeds are passed through three separate dryers that removes in excess of 95% of the water from the adhesive seed mixture.

Those skilled in the art will appreciate that the conception, upon which this disclosure is based, may readily be utilized as a basis for designing other structures, methods, and systems for carrying out the several purposes of the present invention. It is important, therefore, that this description be regarded as including such equivalent constructions insofar as they do not depart from the spirit and scope of the present invention.

Although certain example methods, apparatus, apparatus and articles of manufacture have been described herein, the scope of coverage of this application is not limited thereto. On the contrary, this application covers all methods, apparatus and articles of manufacture fairly falling within the scope of the invention either literally or under the doctrine of equivalents.

Therefore, the foregoing is considered as illustrative only of the principles of a method for creating assignments in an incident command system. Further, since numerous modifications and changes will readily occur to those skilled in the art, it is not desired to limit the method for creating assignments in an incident command system to the exact construction and operation described, and accordingly, all suitable modifications and equivalents may be resorted to, falling within the scope of the present invention. While the above description describes various embodiments of the present invention, it will be clear that the present invention may be otherwise easily adapted to fit other configurations.

As various changes could be made in the above constructions without departing from the scope of the invention, it is intended that all matter contained in the above description shall be interpreted as illustrative and not in a limiting sense.

What is claimed is:

1. A seed adhesive mixture comprising:
water;
a polymer;
a diol;
a defoamer;
wherein the diol comprises 0.5% to 10% of the mixture.

2. The mixture of claim 1 wherein the polymer is polyvinyl alcohol.

3. The mixture of claim 2 wherein the polyvinyl alcohol comprises less than 10% of the mixture.

4. The mixture of claim 1 wherein the diol is ethylene glycol.

5. The mixture of claim 1 wherein the defoamer comprises less than 1% of the mixture.

6. The mixture of claim 1 further comprising sugar.

7. A seed adhesive mixture comprising:
water;
polyvinyl alcohol;
ethylene glycol;
defoamer;
wherein the polyvinyl alcohol comprises less than 10% of the mixture, the ethylene glycol comprises 0.5% to 10% of the mixture, and the defoamer comprises less than 1% of the mixture.

8. The mixture of claim 7 further comprising sugar.

9. The mixture of claim 7 wherein the sugar comprises 8% of the mixture.

10. The mixture of claim 7 further comprising a fungicide.

11. The mixture of claim 7 wherein the polyvinyl alcohol comprises 8% of the mixture.

12. The mixture of claim 7 wherein the ethylene glycol comprises 3% of the mixture.

13. The mixture of claim 7 wherein the defoamer comprises 0.0008% of the mixture.

14. The mixture of claim 7 wherein the defoamer is a silicone defoamer.

15. A method for making a seed adhesive mixture comprising:
adding water to a mixer;
heating the water;
adding a polymer to the heated water;
mixing the water and the polymer;
adding a defoamer to the water and polymer;
adding a diol to the water and polymer.

16. The method of claim 15 wherein polymer is polyvinyl alcohol.

17. The method of claim 15 wherein the diol is ethylene glycol.

18. The method of claim 15 wherein the defoamer is a silicone defoamer.

19. The method of claim 15 further comprising adding sugar to the mixture.

20. The method of claim 15 further comprising adding a fungicide to the mixture.
